(19) United States
(12) Patent Application Publication
(10) Pub. No.: US 2025/0101969 A1
(43) Pub. Date: Mar. 27, 2025

(54) Fracturing Device

(71) Applicant: YANTAI JEREH PETROLEUM EQUIPMENT & TECHNOLOGIES CO., LTD., Yantai (CN)

(72) Inventors: Junlong DU, Yantai (CN); Rikui ZHANG, Yantai (CN); Dong LIU, Yantai (CN); Peng ZHANG, Yantai (CN); Xubin HOU, Yantai (CN)

(73) Assignee: YANTAI JEREH PETROLEUM EQUIPMENT & TECHNOLOGIES CO., LTD., Yantai (CN)

(21) Appl. No.: 18/942,017

(22) Filed: Nov. 8, 2024

(30) Foreign Application Priority Data
Sep. 26, 2023 (CN) 202311253023.9

(51) Int. Cl. F04B 17/05; E21B 43/26; F04B 49/10

(52) U.S. Cl. CPC F04B 17/05; E21B 43/2607; F04B 49/103; F04B 2201/124

(57) ABSTRACT

A device may include a driving mechanism, a clutch brake assembly and a fracturing apparatus, where the clutch brake assembly includes a housing, an input shaft, an output shaft, a clutch mechanism and a brake mechanism; the clutch mechanism and the brake mechanism are respectively disposed at two sides in an axial direction of the clutch brake assembly, and are sheathed on the output shaft; one end of the input shaft is connected with the driving mechanism; the other end of the input shaft penetrates into the housing and is respectively connected with the clutch mechanism and one end of the output shaft; and the other end of the output shaft penetrates out of the housing to be connected with the fracturing apparatus. When the fracturing apparatus stops operating, the driving mechanism can continuously operate, a condition of topspeed brake can be avoided.

### CROSS REFERENCE

This application is based on and claims the benefit of priority to Chinese Patent Application No. 202311253023.9, filed on Sep. 26, 2023, the entirety of which is herein incorporated by reference.

### TECHNICAL FIELD

The present application relates to the technical field of fracturing equipment, in particular to a fracturing device used in an oil/gas well site.

### BACKGROUND

Compared with a traditional diesel engine, a turbine engine has various advantages. For example, a single-machine power density is high, the fuel consumption is low, and the fuel may be 100% natural gas, so that the fuel cost can be lowered, and the environment pollution can be reduced. The turbine engine achieves portability, high reliability, good matching characteristics, good transient response characteristics, etc. Therefore, the turbine engine has been used as a prime mover in some fracturing systems to drive fracturing devices.

However, if the turbine engine is directly applied to a fracturing apparatus, the loading impact may be easily caused on the fracturing apparatus, thus influencing the service life of the fracturing device.

### SUMMARY

The purpose of the present application is to provide a fracturing device capable of avoiding the impact on a fracturing apparatus and prolonging the service life of the fracturing device.

Therefore, in a first aspect, an embodiment of the present application provides a fracturing device which includes a driving mechanism, a clutch brake assembly and a fracturing apparatus.

The clutch brake assembly includes a housing, an input shaft, an output shaft, a clutch mechanism and a brake mechanism, the output shaft is rotatably installed in the housing, and the clutch mechanism and the brake mechanism are respectively disposed at two sides in an axial direction of the clutch brake assembly, and are sheathed on the output shaft.

One end of the input shaft is connected with the driving mechanism, the other end of the input shaft penetrates into the housing and is respectively connected with the clutch mechanism and one end of the output shaft, and the other end of the output shaft penetrates out of the housing to be connected with the fracturing apparatus.

In a possible implementation, the clutch mechanism includes a clutch outer gear sleeve, a clutch friction plate set and a clutch inner gear sleeve which are sequentially disposed in a radial direction of the clutch brake assembly. The clutch inner gear sleeve is connected with the input shaft, the clutch outer gear sleeve is sheathed on the output shaft, and the clutch friction plate set is respectively connected with the clutch inner gear sleeve and the clutch outer gear sleeve.

The clutch mechanism further includes a clutch actuator and a first elastic reset element, the clutch actuator and the first elastic reset element are positioned between the clutch outer gear sleeve and the clutch inner gear sleeve; where the clutch actuator is connected with the clutch friction plate set, and the first elastic reset element is connected with the clutch actuator.

The clutch actuator is able to drive the clutch friction plate set to slide in an axial direction of the clutch brake assembly so that the clutch mechanism is in an open or closed state.

In a possible implementation, the clutch friction plate set includes a plurality of first clutch friction plates and a plurality of second clutch friction plates.

The first clutch friction plates and the second clutch friction plates are sequentially disposed in a crossed manner in the axial direction of the clutch brake assembly; where the first clutch friction plates are connected with the clutch inner gear sleeve, and the second clutch friction plates are connected with the clutch outer gear sleeve.

The clutch actuator is able to drive the first clutch friction plates and the second clutch friction plates to slide in the axial direction of the clutch brake assembly.

In a possible implementation, the brake mechanism includes a brake inner gear sleeve, a brake outer gear sleeve and a brake friction plate set. The brake inner gear sleeve is fixedly connected with the housing, the brake outer gear sleeve is sheathed on the output shaft, and the brake friction plate set is respectively connected with the brake inner gear sleeve and the brake outer gear sleeve.

The brake mechanism further includes a brake actuator and a second elastic reset element, the brake actuator and the second elastic reset element are positioned between the brake inner gear sleeve and the brake outer gear sleeve; where the brake actuator is connected with the brake friction plate set, and the second elastic reset element is connected with the brake actuator.

The brake actuator is able to drive the brake friction plate set to slide in an axial direction of the clutch brake assembly so that the brake mechanism is in an open or closed state.

In a possible implementation, the brake friction plate set includes a plurality of first brake friction plates and a plurality of second brake friction plates.

The first brake friction plates and the second brake friction plates are sequentially disposed in a crossed manner in the axial direction of the clutch brake assembly; where the first brake friction plates are connected with the brake inner gear sleeve, and the second brake friction plates are connected with the brake outer gear sleeve.

The brake actuator is able to drive the first brake friction plates and the second brake friction plates to slide in the axial direction of the clutch brake assembly.

In a possible implementation, the clutch brake assembly further includes an oil passage.

The oil passage penetrates through the housing and communicates with the brake mechanism and/or the clutch mechanism.

In a possible implementation, the driving mechanism includes a gas turbine engine and a first reduction gear box.

The gas turbine engine is connected with the first reduction gear box, and the first reduction gear box is connected with the clutch mechanism through the input shaft.

The gas turbine engine is a gas turbine single-shaft engine or a gas turbine double- shaft engine.

In a possible implementation, in a case that the gas turbine engine is a gas turbine single-shaft engine, the fracturing device further includes an auxiliary driving mechanism.

One side of the auxiliary driving mechanism is connected with the brake mechanism through the output shaft, and the other side of the auxiliary driving mechanism is connected with the fracturing apparatus.

In a possible implementation, the auxiliary driving mechanism includes a second reduction gear box, an adjustable-speed driving motor and the other clutch brake assembly.

The adjustable-speed driving motor is connected to the second reduction gear box through the other clutch brake assembly, and the second reduction gear box is respectively connected with the output shaft and the fracturing apparatus.

In a possible implementation, in a case that the gas turbine engine is a gas turbine single-shaft engine, the fracturing device further includes a gear box, and the gear box is disposed in parallel to the clutch brake assembly.

One side of the gear box is connected with the first reduction gear box, and the other side of the gear box is connected with the fracturing apparatus.

In a possible implementation, the fracturing apparatus includes a second reduction gear box, a third reduction gear box and a fracturing pump in sequential connection.

The second reduction gear box is positioned at one side near the clutch brake assembly, and the fracturing pump is positioned at one side far away from the brake clutch assembly.

According to the fracturing device provided by the embodiment of the present application, the clutch brake assembly is disposed between the driving mechanism and the fracturing apparatus, and the fracturing device integrating the brake function and the clutch function is realized. When the fracturing apparatus stops working, the driving mechanism can continuously operate, a condition of topspeed brake is avoided, and the service life of the fracturing device is effectively prolonged.

### BRIEF DESCRIPTION OF THE DRAWINGS

The drawings herein are incorporated into the specification and form a part of the specification, showing embodiments conforming to the present application and being used together with the specification to explain the principle of the present application.

To describe the technical solutions of the embodiments of the present application or in the related art more clearly, the following briefly introduces the accompanying drawings for describing the embodiments or the related art. Apparently, a person of ordinary skill in the art may still derive other drawings from these accompanying drawings without creative efforts.

One or more embodiments are exemplified by pictures in the accompanying drawings to which they correspond, but these exemplary descriptions do not constitute a limitation to the embodiments, and elements having the same reference numerals in the accompanying drawings represent as similar elements. Unless otherwise specified, the figures in the accompanying drawings are not necessarily drawn to scale and thus do not constitute a scale limitation.

FIG. 1 shows a structure block diagram of a fracturing device provided by an embodiment of the present application.

FIG. 2 shows a structure block diagram of a fracturing device provided by an embodiment of the present application.

FIG. 3 shows a structure block diagram of a fracturing device provided by an embodiment of the present application.

FIG. 4A shows an example schematic structure diagram of a clutch brake assembly provided by an embodiment of the present application.

FIG. 4B further shows example details in the schematic structure diagram of the clutch brake assembly of FIG. 4A.

FIG. 5 shows a schematic diagram of control pressure and transfer torque capability relationship curves provided by an embodiment of the present application.

FIG. 6 is a schematic diagram of change curves of each parameter along with time provided by an embodiment of the present application.

### DESCRIPTIONS OF REFERENCE NUMERALS

1 denotes a driving mechanism. 11 denotes a gas turbine engine. 111 denotes a gas turbine single-shaft engine. 1111 denotes a second gas compressor. 1112 denotes a second gas compressor turbine. 1113 denotes a second power turbine. 1114 denotes a second combustion chamber. 112 denotes a gas turbine double-shaft engine. 1121 denotes a first gas compressor. 1122 denotes a first gas compressor turbine. 1123 denotes a first power turbine. 1124 denotes a first combustion chamber. 12 denotes a first reduction gear box. 121 denotes a turbine engine starting motor. 122 denotes an electric generator or start-up and electric generation all-in-one machine. 13 denotes a transmission shaft.

2 denotes a clutch brake assembly. 21 denotes a housing. 22 denotes an input shaft. 23 denotes an output shaft. 24 denotes a clutch mechanism. 241 denotes a clutch outer gear sleeve. 242 denotes a clutch friction plate set. 2421 denotes a first clutch friction plate. 2422 denotes a second clutch friction plate. 243 denotes a clutch inner gear sleeve. 244 denotes a clutch actuator. 2441 denotes a support frame. 245 denotes a first elastic reset element. 25 denotes a brake mechanism. 251 denotes a brake inner gear sleeve. 252 denotes a brake outer gear sleeve. 253 denotes a brake friction plate set. 2531 denotes a first brake friction plate. 2532 denotes a second brake friction plate. 254 denotes a brake actuator. 255 denotes a second elastic reset element. 26 denotes an oil passage. 261 denotes a first oil passage. 262 denotes a second oil passage. 263 denotes a third oil passage.

3 denotes a fracturing apparatus. 31 denotes a third reduction gear box. 32 denotes a fourth reduction gear box. 33 denotes a fracturing pump.

4 denotes an auxiliary driving mechanism. 41 denotes a second reduction gear box. 42 denotes an adjustable-speed driving motor.

5 denotes a gear box.

### DETAILED DESCRIPTION

In order to describe the purpose, the technical solution and the advantages of embodiments of the present application more clearly, the technical solution of embodiments of the present application will be described hereinafter with reference to the accompanying drawings in this embodiment of the present application. Obviously, the described embodiments are only a few, but not all, embodiments of the present application. All other embodiments derived by a person of ordinary skill in the art based on the embodiments of present application without making creative efforts shall fall within the protection scope of the present application.

The disclosure hereafter provides different embodiments or examples for realizing different structures of the present application. In order to simplify the disclosure of the present application, components and arrangement of specific examples are described hereafter. Of course, they are only examples, and are not intended to limit the present application. Additionally, the reference numerals and/or letters may be repeated in different examples. Such repetition is to achieve the purposes of simplification and clarification, and it does not indicate the relationship among various discussed embodiments and/or arrangements.

For convenient description, the terms showing spatial relative relationships may be used herein to describe the relative position relationship or motion condition of a component or feature shown in the figure relative to another component or feature. These terms showing the relative position relationships, for example, include “internal”, “external”, “inside”, “outside”, “below”, “under”, “on”, “above”, “front”, “rear”, etc. These terms showing spatial relative relationships are meant to include different orientations of the apparatuses in use or operation other than those depicted in the figures. For example, if an apparatus in the figure has a position reversal or attitude change or motion state change, these directional indications will change accordingly. For example, a component described as “below another component or feature” or “under another component or feature” will be then changed as “on another component or feature” or “above another component or feature”. Therefore, an exemplary term “under” may include two space orientations: upper and lower orientations. The apparatus may in other orientations (rotated for 90° or in other directions), and may be correspondingly explained by a spatial relative relationship descriptor used in the description.

In order to solve the technical problems that the loading impact may be easily caused on a fracturing apparatus, and the service life of the fracturing apparatus is influenced, the present application provides a fracturing device integrating a brake function and a clutch function. When the fracturing apparatus stops operation, a driving mechanism can continuously operate, a condition of topspeed braking is avoided, and the service life of the fracturing device is effectively prolonged.

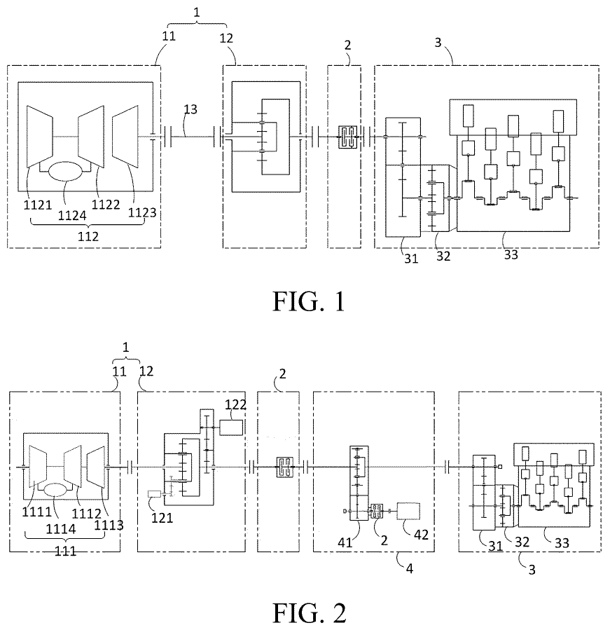

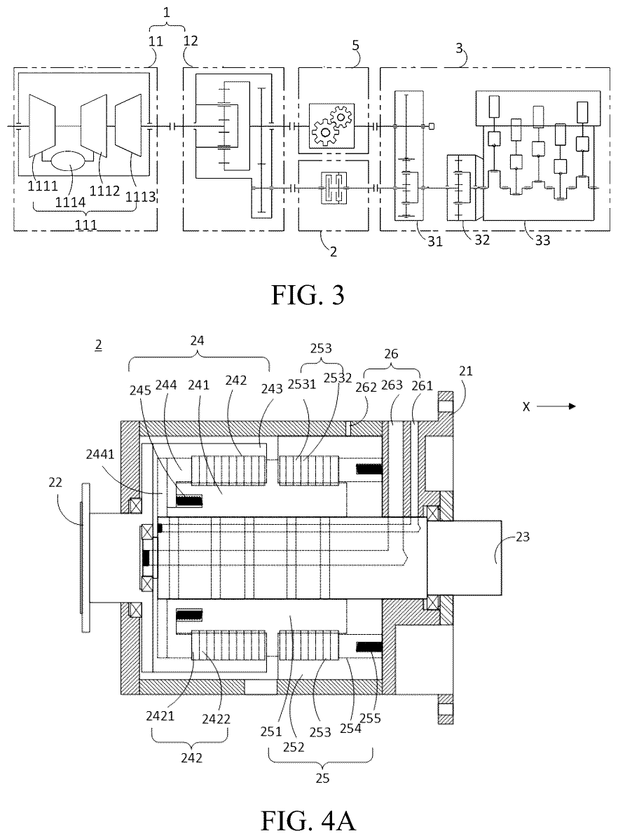

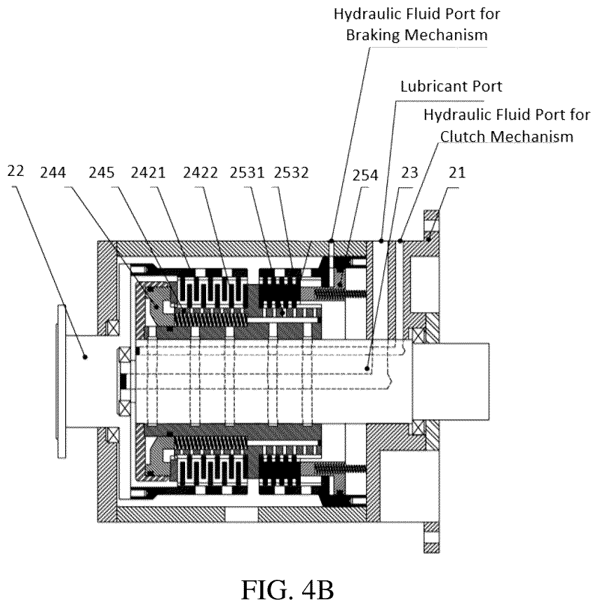

FIG. 1 shows a structure block diagram of a fracturing device provided by an embodiment of the present application; FIG. 2 shows another structure block diagram of a fracturing device provided by an embodiment of the present application; FIG. 3 shows yet another structure block diagram of a fracturing device provided by an embodiment of the present application; and FIG. 4 shows a schematic structure diagram of a clutch brake assembly provided by an embodiment of the present application.

In some exemplary embodiments, as shown in FIG. 1 to FIG. 4, a fracturing device provided by an embodiment of the present application includes a driving mechanism 1, a clutch brake assembly 2 and a fracturing apparatus 3. The driving mechanism 1 is connected with the fracturing apparatus 3 through the clutch brake assembly 2 to realize the fracturing device with a brake function and a clutch function.

As shown in FIG. 4, the clutch brake assembly 2 includes a housing 21, an input shaft 22, an output shaft 23, a clutch mechanism 24 and a brake mechanism 25. The output shaft 23 is rotatably installed in the housing 21. The clutch mechanism 24 and the brake mechanism 25 are respectively disposed at two sides in an axial direction (refer to an axis X as shown in FIG. 4) of the clutch brake assembly, and are sheathed on the output shaft 23.

One end of the input shaft 22 is connected with the driving mechanism 1, so that the driving mechanism 1 can drive the input shaft 22 to rotate. The other end of the input shaft 22 penetrates into the housing 21 and is respectively connected with the clutch mechanism 24 and one end of the output shaft 23. The other end of the output shaft 23 penetrates out of the housing 21 to be connected with the fracturing apparatus 3, so as to drive the fracturing apparatus 3 to operate.

The clutch mechanism 24 and the brake mechanism 25 may operate in a manner of being independent from each other so as to achieve the purpose that the driving mechanism 1 continuously operates when the fracturing apparatus 3 stops operating. Each of the clutch mechanism 24 and the brake mechanism 25 may operate in an open state or closed state. When the clutch mechanism 24 is in the open state, the clutch does not engage between the input shaft and the output shaft. When the clutch mechanism is in the closed state, the clutch engages between the input shaft and the output shaft via friction such that the input shaft can drive the output shaft. Similar, when the brake mechanism is in the open state, the braking of the output shaft is not engaged whereas when the brake mechanism is in the closed state, the braking of the output shaft would be in action. The switching between the open state and the closed state for either one of the clutch mechanism 24 or the brake mechanism 25 may be achieved by controlling a respective actuator to be enabled to disabled. Both the clutch mechanism 24 and the brake mechanism 25 may be structurally configured in a normally open configuration or normally closed configuration. Whether the clutch mechanism or the brake mechanism is normally open or normally close depends on the operating state of the clutch mechanism or brake mechanism when the actuator is disabled (e.g., when hydraulic pressure is not applied (or disabled) for a hydraulically controlled actuator).

For example, in a normally open clutch configuration, when the actuator for the clutch is disabled, the clutch mechanism 24 would be in the open state whereas when the actuator for the clutch is enabled, the clutch mechanism 24 would be in the closed state. In a normally closed clutch configuration, when the actuator for the clutch is disabled, the clutch mechanism 24 would be in the closed state, whereas when the actuator for the clutch is enabled, the clutch mechanism 24 would be in the open state,

Similarly, in a normally open braking configuration, when the actuator for the brake is disabled, the brake mechanism 25 would be in the open state whereas when the actuator for the brake is enabled, the brake mechanism 25 would be in the closed state. In a normally closed braking configuration, when the actuator for the brake is disabled, the brake mechanism 25 would be in the closed state, whereas when the actuator for the braking is enabled, the brake mechanism 25 would be in the open state, The clutch brake assembly 2 above may include a clutch mechanism 24 and brake mechanism 25 in any configuration (normally open or normally closed), e.g., normally open clutch mechanism in combination with a normally open brake mechanism, or normally open clutch mechanism in combination with a normally closed brake mechanism clutch, or normally closed clutch mechanism in combination with a normally open brake mechanism, or, normally closed clutch mechanism in combination with a normally closed brake mechanism.

When the driving mechanism 1 converts from an idle mode to a work mode, the clutch mechanism 24 can be controlled to be in the closed state (engaged state), and the brake mechanism 25 can be controlled to be in the open state (non-braking), so that the clutch mechanism 24 is in an enabled state, and the brake mechanism 25 is in a disabled state. The driving mechanism 1 drives the fracturing apparatus 3 to operate through the clutch brake assembly 2, the power transfer torque of the driving mechanism 1 is controlled to be slowly increased, so that the output torque of the clutch mechanism 24 is also slowly increased, a slow control process of the clutch mechanism 24 and the brake mechanism 25 is realized, a better soft starting effect is achieved, and the influence of the loading impact on a power transmission system is reduced.

In some exemplary embodiments, as shown in FIG. 4A and further detail in FIG. 4B, the clutch mechanism 24 is illustrated in a normally open configuration and includes a clutch outer gear sleeve 241, a clutch friction plate set 242 and a clutch inner gear sleeve 243 sequentially disposed in a radial direction of the clutch brake assembly.

The axial end surface of the clutch inner gear sleeve 243 is connected with the other end of the input shaft 22, and the input shaft 22 can drive the clutch inner gear sleeve 243 to rotate. The clutch outer gear sleeve 241 is sheathed on the output shaft 23, and the output shaft 23 can rotate together with the clutch outer gear sleeve 241. The clutch friction plate set 242 is sheathed on the radial outer side of the clutch outer gear sleeve 241. The clutch fraction plate set 242 include two interleaving subsets of fraction plates, one subset being connected with the clutch inner gear sleeve 243 and the other subset being connected with the clutch outer gear sleeve 241.

The clutch mechanism 24 further includes a clutch actuator 244 and a first elastic reset element 245. The clutch actuator 244 and the first elastic reset element 245 are positioned between the clutch outer gear sleeve 241 and the clutch inner gear sleeve 243. One right end of the clutch actuator 244 is connected with the clutch friction plate set 242. The first elastic reset element 245 is connected with the other right end of the clutch actuator 244. The left end of the clutch actuator 244 connects to a chamber that can be hydraulically pressured or enabled to push the actuator 244 to the right. The hydraulic fluid is supplied through the hydraulic fluid port for clutch mechanism as indicated in FIG. 4B.

The clutch actuator 244 is able to be installed on the output shaft 23 by using a support frame 2441, so that the installation of the clutch actuator 244 is more reliable. The support frame 2441, for example, is sheathed on the output shaft 23, and the clutch actuator 244 is connected with the support frame 2441 through a bearing assembly (not shown in the figure). The first elastic reset element 245, for example, is a compression spring, and is disposed at the radial outer side of the clutch outer gear sleeve 241. The clutch actuator 244 is fixedly connected with the first elastic reset element 245. The clutch actuator 244 is able to drive the clutch friction plate set 242 to slide in an axial direction of the clutch brake assembly 2 so that the example clutch mechanism 24 of FIG. 4A and FIG. 4B can be controlled to operate in either the open or the closed state.

In the normally open clutch configuration of FIG. 4A and FIG. 4B, when the actuator 244 is not enabled, the reset element is compressed and pushes the actuator 244 to the left, away from and thereby releasing pressure between the subset plates within the clutch fraction plates 242. The clutch is thus in the open state. When the clutch actuator 244 is in an enabled state, the clutch actuator 244 is driven to the right, thereby extruding the clutch friction plate set 242 to realize the closed state of the clutch friction plate set 242. The first elastic reset element 245 is also synchronously extruded to realize further contraction (compression) distortion and further store distortion energy. When the clutch actuator 244 switch to being disabled\, the exerted extrusion force is removed, the first elastic reset element 245 provides resistance force to backwards push the clutch actuator 244 to the left and to realize the reset, and the pressure within the clutch friction plate set 242 is removed and the clutch mechanism return to the open state.

In some example embodiments, the clutch friction plate set 242 includes a plurality of first clutch friction plates 2421 and a plurality of second clutch friction plates 2422 (the subsets of friction plates described above). The first clutch friction plates 2421 and the second clutch friction plates 2422 are all in annular shapes and are sequentially sheathed at the radial outer side of the clutch outer gear sleeve 241. The first clutch friction plates 2421 and the second clutch friction plates 2422 are sequentially disposed in a crossed manner in the axial direction of the clutch brake assembly; the first clutch friction plates 2421 are connected with the clutch inner gear sleeve 243, and the second clutch friction plates 2422 are connected with the clutch outer gear sleeve 241.

The clutch actuator 244 is able to drive the first clutch friction plates 2421 and the second clutch friction plates 2422 to slide in an axial direction of the clutch brake assembly so that the first clutch friction plates 2421 and the second clutch friction plates 2422 are compressed with each other or separated from each other, and the closed or open state of the clutch mechanism 24 is realized. When the first clutch friction plates 2421 and the second clutch friction plates 2422 are compressed with each other, the clutch mechanism 24 is in the closed state. When the first clutch friction plates 2421 and the second clutch friction plates 2422 are separated from each other, the clutch mechanism 24 is in the open state.

In some exemplary embodiments, as shown in FIG. 4A and in further detail in FIG. 4B, the brake mechanism 25 may be configured in a normally closed configuration and may includes a brake inner gear sleeve 251, a brake outer gear sleeve 252 and a brake friction plate set 253.

The radial outer side wall of the brake outer gear sleeve 252 is fixedly connected with the housing 21. The brake inner gear sleeve 251 is sheathed on the output shaft 23, and the output shaft 23 can rotate with and the brake inner gear sleeve 251. The brake friction plate set 253 is sheathed on the radial outer side of the brake outer gear sleeve 252. The brake friction plate set 253 may include two interleaving subsets of friction plates, one subset being connected to the brake inner gear sleeve 251 and the other subset being connected to the brake outer gear sleeve 252.

The brake mechanism 25 further includes a brake actuator 254 and a second elastic reset element 255. The brake actuator 254 and the second elastic reset element 255 are positioned between the brake inner gear sleeve 251 and the brake outer gear sleeve 252. The left end of the brake actuator 254 is connected with the brake friction plate set 253. The second elastic reset element 255 is connected with the brake actuator 254. The second elastic reset element 255, for example, may be a compression spring, one end of the second elastic reset element (the right end) is connected with the housing 21, the other end of the second elastic reset element (the left end) is connected with one end of the brake actuator 254, and the other end of the brake actuator 254 is connected with the brake friction plate set 253.

The brake actuator 254 is able to drive the brake friction plate set 253 to slide in an axial direction of the clutch brake assembly so that the brake mechanism 25 can be controlled to operate in the open state or closed state.

In the normally closed clutch configuration of FIG. 4A and FIG. 4B, when the actuator 254 is disabled, the actuator 254 is pushed by the compressed elastic reset element to the left, thereby pressing against the brake friction plate set 253 to engage braking. When the brake actuator 254 is in an enabled state (by, e.g., applying hydraulic pressure from the hydraulic fluid port for brake mechanism as indicated in FIG. 4B), the brake actuator 254 is driven to the right and further compresses the elastic reset element and at the same time separates from the braking friction plate, thereby releasing the pressure on the braking friction set 253 to disengage the braking action (into the open state). When the brake actuator 254 is disabled again, the reset would involve the elastic decompression restoring force in the elastic reset element pushing the actuator to the left to compress the fraction plate set 253 to engage braking (closed state).

In some example embodiments, the brake friction plate set 253 includes a plurality of first brake friction plates 2531 and a plurality of second brake friction plates 2532 (the interleaving subsets of friction plated described above). The first brake friction plates 2531 and the second brake friction plates 2532 are all in annular shapes and are sequentially sheathed at the outer side of the brake outer gear sleeve 252. The first brake friction plates 2531 and the second brake friction plates 2532 are sequentially disposed in a crossed manner in the axial direction of the clutch brake assembly; the first brake friction plates 2531 are connected with the brake inner gear sleeve 251, and the second brake friction plates 2532 are connected with the brake outer gear sleeve 252.

The brake actuator 254 is able to drive the first brake friction plates 2531 and the second brake friction plates 2532 to slide in an axial direction of the clutch brake assembly so that the first brake friction plates 2531 and the second brake friction plates 2532 are compressed with each other or separated from each other, and the closed or open state of the brake mechanism 25 is realized. When the first brake friction plates 2531 and the second brake friction plates 2532 are compressed with each other, the brake mechanism 25 is in the closed state. When the first brake friction plates 2531 and the second brake friction plates 2532 are separated from each other, the brake mechanism 25 is in the open state.

The above example of FIG. 4A and FIG. 4B includes the clutch mechanism in the normally open configuration and the brake mechanizing in the normally closed configuration. However, as described above, this is a merely example, other alternative combinations can be implemented.

For example, the structure characteristics of the actuators and elastic reset mechanisms above for the clutch mechanism may be used for the brake mechanism so as to achieve a normally open braking. In that configuration, when the actuator 254 is disabled, the elastic reset element would be compressed to push the actuator 254 to the right so as to decompress the brake friction plates. When the actuator 254 is enabled, it would push the actuator 254 to move to the left to compress the friction plates to engage braking, and the elastic reset element would be further compressed. When the actuator is disabled again, the restoring force in the elastic reset element would drive the actuator 254 to the right to reset to the open state.

Similarly, the structural characteristics of the actuator and elastic reset elements for the braking mechanism in FIG. 4A and FIG. 4B may be applied to the clutch side to achieve a normally closed clutch configuration.

Herein, it needs to be noted that the brake inner gear sleeve 251 and the clutch inner gear sleeve 243 may be independent from each other to avoid mutual interference. Or, they may be of an integral structure, so that the forming is convenient, the production efficiency is improved, and the cost is lowered. The structure is specifically according to the actual situations.

It further needs to be noted that the clutch actuator 244 and the brake actuator 254 may operate or be controlled in any one form of a pneumatic form, a hydraulic form, an electromagnetic form, etc., and it is specifically according to the actual situations. In the present application, a hydraulic driving form is taken as a mere example for illustration. A hydraulic driving form apparatus is an apparatus for generating mechanical motion by using pressure of compressed liquid. The liquid, for example, may be a pressure oil, and a control oil path is formed in the hydraulic driving form structure.

In some exemplary embodiments, as shown in FIG. 4, the clutch brake assembly 2 further includes an oil passage 26. The oil passage 26 penetrates through the housing 21 and communicates with the brake mechanism 25 and/or the clutch mechanism 24 so as to lubricate the brake mechanism and/or the clutch mechanism.

In some examples, the oil passage 26 includes a first oil passage 261, the first oil passage 261 penetrates through the housing 21 in the radial direction of the clutch brake assembly 2, and communicates with the brake inner gear sleeve 251 of the brake mechanism 25. The brake inner gear sleeve 251 is provided with a plurality of first through holes (not shown in the figures) in the radial direction so as to ensure lubricating oil to be able to enter the brake mechanism from the first oil passage 261, and the brake mechanism 25 can be lubricated through the plurality of first through holes.

It can be understood that the positions of the through holes may be distributed in the positions of the brake friction plate set 253, the brake actuator 254, etc. to ensure that each portion of the brake mechanism 25 may be infiltrated by the lubricating oil, and the friction resistance is effectively reduced.

In some examples, the oil passage 26 includes a second oil passage 262, the second oil passage 262 penetrates through the housing 21 in the radial direction of the clutch brake assembly 2, and communicates with the clutch mechanism 24. The second oil passage 262 may be directly disposed at one side of the clutch mechanism 24, and the arrangement manner of the second oil passage is the same as the arrangement manner at the brake mechanism 25, so it is not repeated herein. Or, when each of the clutch mechanism 24 and the brake mechanism 25 is respectively provided with an oil passage 26, in order to achieve convenient design, convenient lubricating oil feeding, etc., the first oil passage 261 and the second oil passage 262 are disposed at one side, the second oil passage 262 penetrates through the housing 21 to the output shaft 23, the output shaft 23 is provided with a flowing passage (not shown in the figures) penetrating through the output shaft 23 in the radial direction and axial direction. The flowing passage communicates with the second oil passage 262. In addition, a plurality of second through holes (not shown in the figures) communicating with the flowing passage are formed in the radial direction of the output shaft 23 so as to communicate with the clutch outer gear sleeve 241, the clutch outer gear sleeve 241 is provided with third through holes (not shown in the figures) matched with the through holes to ensure the lubricating oil to be able to flow in the clutch mechanism through the second oil passage 262, and the clutch mechanism 24 can be infiltrated by the lubricating oil sequentially through the flowing passage, the second through holes and the third through holes.

Of course, it can be understood that the through holes and the flowing passage in the clutch brake assembly 2 are not limited to the above arrangement manner and quantity. For reasonable layout, other through holes may also be formed to assist the flowing of the lubricating oil as long as the lubricating oil is enabled to achieve the infiltration lubrication on the brake mechanism 25 and the clutch mechanism 24, and it is specifically according to the actual situations.

Additionally, besides the oil passage 26 and besides the above arrangement manner, a third oil passage 263 penetrating through the housing 21 may further be included, and the third oil passage 263 is configured to lubricate the output shaft 23 and the input shaft 22. For example, the output shaft 23 is provided with a lubricating passage (not shown in the figures) penetrating through the radial direction and axial direction, the passage in the axial direction is coaxial with the output shaft 23, and extends to the input shaft 22 so that the lubricating oil may flow to the input shaft 22. A plurality of fourth through holes (not shown in the figures) are formed in the radial direction so as to realize the lubrication on the output shaft 23. The fourth through holes and the second through holes may be the same holes to simplify the structure layout and achieve convenient forming.

Herein, it needs to be noted that the oil passage 26 may bring away heat in the brake and clutch process and ensure rotating speed and power transfer between the friction plates according to the preset requirements, so that the time set for the closed state or open state of the clutch and brake can be reached.

The clutch mechanism 24 and the brake mechanism 25 may share one oil passage 26 and one inlet, they may be respectively independent as shown in the above embodiments, and the form is specifically according to the actual situations.

In some exemplary embodiments, as shown in FIG. 1 to FIG. 4, the driving mechanism 1 includes a gas turbine engine 11 and a first reduction gear box 12. The gas turbine engine 11 is connected with the first reduction gear box 12, the first reduction gear box 12 is connected with the clutch mechanism 24 through the input shaft 22 so as to realize the driving on the clutch brake assembly 2, and the fracturing apparatus 3 is driven by the clutch brake assembly 2 to operate.

The form of the gas turbine engine 11 can be flexible, the gas turbine engine may be a gas turbine single-shaft engine 111 with higher efficiency; or may be a gas turbine double-shaft engine 112 with more environmental-friendly emission, and the form is specifically according to the actual situations. The gas turbine engine 11 in different forms may be provided with different accessories.

The gas turbine single-shaft engine 111 and the gas turbine double-shaft engine 112 are respectively exemplarily illustrated hereafter.

As shown in FIG. 1 and FIG. 4, in a case that the gas turbine engine 11 is a gas turbine double-shaft engine 112, the first reduction gear box 12 is a planetary reduction gear box, the friction in the transmission process of the planetary reduction gear box is very small, and the friction coefficient is low, so that the stall probability is very low. In addition, the friction coefficient and the friction in the motion process of the planetary reduction gear box are very small, so that the high stability of a speed reducer during operation can be ensured, and the abnormal sound and vibration in the transmission process can be avoided, so that the operation of the machine is more stable and reliable.

The gas turbine double-shaft engine 112 includes a first gas compressor 1121, a first gas compressor turbine 1122 and a first power turbine 1123. The first gas compressor 1121 and the first gas compressor turbine 1122 are coaxially connected, and rotate at the same speed, and a first combustion chamber 1124 is disposed between the first gas compressor and the first gas compressor turbine. The first power turbine 1123 is positioned at one side of the first gas compressor turbine 1122 far away from the first gas compressor 1121, and is disposed on the other shaft, the free first power turbine 1123 is realized, and it may be adjusted in a wider rotating speed range.

The other shaft is used as a power output end to be connected with the input end of the transmission shaft 13, the output end of the transmission shaft 13 is connected with the input end of the first reduction gear box 12, and the output end of the first reduction gear box 12 is connected with the clutch brake mechanism 24 of the clutch brake assembly 2.

As shown in FIG. 2 to FIG. 4, in a case that the gas turbine engine 11 is a turbine single-shaft engine 111, the turbine single-shaft engine 111 is connected with the first reduction gear box 12. The first reduction gear box 12, for example, is a high-speed reduction gear box, the greater torque and lower rotating speed can be realized in a smaller space, lower mechanical loss and higher efficiency are realized, and the energy consumption is effectively reduced.

The gas turbine single-shaft engine 111 includes a second gas compressor 1111, a second gas compressor turbine 1112 and a second power turbine 1113 which are coaxially connected and rotate at the same speed, and the output rotating speed of the turbine single-shaft engine 111 is non-adjustable. A second combustion chamber 1114 is disposed between the second gas compressor 1111 and the second gas compressor turbine 1112. The output end of the second power turbine 1113 is connected with the first input end of the first reduction gear box 12, and the output end of the first reduction gear box 12 is connected with the clutch brake mechanism 24 of the clutch brake assembly 2.

A motor may be disposed in the first reduction gear box 12 so that the first reduction gear box may be singly driven. The motor, for example, is a turbine engine starting motor 121, the first reduction gear box 12, for example, is provided with a second input end, and the turbine engine starting motor 121 is disposed at the second input end. Or, the motor, for example, is an electric generator or start-up and electric generation all-in-one machine 122, the first reduction gear box 12, for example, is provided with a third input end, and the electric generator or start- up and electric generation all-in-one machine 122 is connected with the third input end. Of course, it may be understood that no single motor for driving the first reduction gear box may be disposed in the first reduction gear box 12, and the arrangement is specifically according to actual situations.

In some exemplary embodiments, as shown in FIG. 2 and FIG. 4, in a case that the gas turbine engine 11 is a gas turbine single-shaft engine 111, the fracturing device further includes an auxiliary driving mechanism 4.

One side of the auxiliary driving mechanism 4 is connected with the brake mechanism 25 through the output shaft 23, and the other side of the auxiliary driving mechanism 4 is connected with the fracturing apparatus 3.

In some examples, the auxiliary driving mechanism 4, for example, includes a second reduction gear box 41, an adjustable-speed driving motor 42 and the other clutch brake assembly 2.

The adjustable-speed driving motor 42 is connected to the second reduction gear box 41 through the other clutch brake assembly 2, and the second reduction gear box 41 is respectively connected with the output shaft 23 and the fracturing apparatus 3. The second reduction gear box 41, for example, is an adjustable-speed planetary reduction gear box.

In some exemplary embodiments, as shown in FIG. 3 and FIG. 4, in a case that the gas turbine engine 11 is a gas turbine single-shaft engine 111, the fracturing device further includes a gear box 5. The gear box 5 is disposed in parallel to the clutch brake assembly 2. The gear box 5 has a plurality of shifts to meet different rotating speed requirements.

One side of the gear box 5 is connected with the first reduction gear box 12, and the other side of the gear box 5 is connected with the fracturing apparatus 3.

In some exemplary embodiments, as shown in FIG. 1 to FIG. 3, the fracturing apparatus 3 includes a third reduction gear box 31, a fourth reduction gear box 32 and a fracturing pump 33 which are in sequential connection.

The third reduction gear box 31 is positioned at one side near the clutch brake assembly 2, and the fracturing pump 33 is positioned at one side far away from the brake clutch assembly 2.

The third reduction gear box 31 and the fourth reduction gear box 32, for example, may be in integral arrangement, and may also be in split arrangement. In a case that the third reduction gear box and the fourth reduction gear box are in integral arrangement, the third reduction gear box 31, for example, is a parallel reduction gear box, and the fourth reduction gear box 32, for example, is a planetary reduction gear box. In a case that the third reduction gear box and the fourth reduction gear box are in split arrangement, the third reduction gear box 31, for example, is an adjustable-speed planetary reduction gear box, and the fourth reduction gear box 32, for example, is a planetary reduction gear box. The third reduction gear box 31 and the fourth reduction gear box 32 are specifically according to the actual design.

The clutch brake assembly 2, the driving mechanism 1, the fracturing apparatus 3, the auxiliary driving mechanism 4 and the reduction gear box 5 have different use methods and combination modes, and they will be further exemplarily illustrated hereafter for convenient understanding.

### Embodiment I

As shown in FIG. 1 and FIG. 4, a fracturing device includes a driving mechanism 1, a clutch brake assembly 2 and a fracturing apparatus 3. The driving mechanism 1, the clutch brake assembly 2 and the fracturing apparatus 3 have been described in details in the above embodiments, and will not be repeated herein. Only the combination mode will be further illustrated herein.

The driving mechanism 1 includes a gas turbine engine 11 and a first reduction gear box 12, the gas turbine engine 11 is a gas turbine double-shaft engine 112, and the first reduction gear box 12 is a planetary reduction gear box.

The fracturing apparatus 3 includes a third reduction gear box 31, a fourth reduction gear box 32 and a fracturing pump 33 which are in sequential connection. The third reduction gear box 31 and the fourth reduction gear box 32 are in integral arrangement.

The gas turbine double-shaft engine 112 is used as a prime mover, and is connected to the first reduction gear box 12 through a transmission shaft 13, the power of the gas turbine double-shaft engine 112 is subjected to speed deceleration and torque increase through the first reduction gear box 12, is then output through the first reduction gear box 12, and is connected to the fracturing apparatus 3 through the other transmission shaft to further drive the fracturing pump 33 to operate.

There is an adjusting requirement on the output flow rate of the fracturing pump 33 in fracturing construction, the rotating speed of a power transmission system needs to be adjusted. According to the fracturing device in the present application, the gas turbine double-shaft engine 112 can realize the adjustment on the rotating speed.

In the practical use process of the fracturing device according to the present application, the gas turbine double-shaft engine 112 has an idle mode, a first gas compressor turbine 1122 rotates, and a first power turbine 1123 is in a no power output mode.

In the related art, in order to prevent the fracturing pump 33 from being driven to rotate by the first power turbine 1123 under the condition of no load or small lad, a brake is installed on the first reduction gear box 12 so that the first power turbine 1123 is forced to stop moving, and the rotating speed is zero.

According to a treatment manner in the related art, the first gas compressor 1121, the first gas compressor turbine 1122 and the first combustion chamber 1124 all maintain operation, there will be a great amount of hot gas exhausted from an exhaust end of the first gas compressor turbine 1122, the hot gas goes out from a first combustion chamber 1124, passes through the first gas compressor 1121 to drive the turbine to rotate, and further drives the first gas compressor 1121 to operate. Then, the hot gas will be exhausted to the exhaust end through the first power turbine 1123. However, in the above process, the first power turbine 1123 has been braked by the brake in a forced manner. When the hot gas is outwards exhausted to pass through the first power turbine 1123, the first power turbine 1123 needs to bear the high temperature and pressure of the gas, and the service life of the first power turbine 1123 may be influenced.

Therefore, due to the arrangement of the clutch brake assembly 2, the first power turbine 1123 may automatically rotate, the brake braking is not needed, and the service life of the first power turbine 1123 is prolonged.

When the first power turbine 1123 is in an idle mode, a clutch actuator 244 of the clutch mechanism 24 controls a clutch friction plate set 242 to be in a separated state, a brake actuator 254 of the brake mechanism 25 controls a brake friction plate set 253 to be in an attached state, so that the power output transmission of the first power turbine 1123 to the fracturing pump 33 is cut off, the fracturing pump 33 is braked by the brake mechanism 25, the rotating speed of the fracturing pump 33 is zero, and the first power turbine 1123 freely rotates. If the rotating speed of the first power turbine 1123 is continuously accelerated, and there is an overspeed trend, the closed degree of the clutch mechanism 24 is slowly increased. Since the clutch mechanism 23 is partially closed, lubricating oil is introduced into the clutch friction plate set 242 to form an oil film, first clutch friction plates 2421 are connected to an input shaft 22 through a clutch inner gear sleeve 243, the first clutch friction plates 2421 are driven by the input shaft 22 to rotate, the second clutch friction plates 2422 are connected to an output shaft 23 through a clutch outer gear sleeve 241, and the second clutch friction plates 2422 are braked by the output shaft 23. There is relative sliding between the first clutch friction plates 2421 and the second clutch friction plates 2422, i.e., there is liquid viscosity and/or sliding friction, and a moment opposite to the rotating direction of the first power turbine 1123 is formed, so that the rotating speed of the first power turbine 1123 is stabilized at a certain value, and the service life of the first power turbine 1123 is prolonged.

When the first power turbine 1123 converts from the idle mode to a work mode, the clutch mechanism 24 is controlled to be in the closed state, and the brake mechanism 25 is in the open state. Through a process of slowly controlling the clutch mechanism 24 and the brake mechanism 25, the slow increase of the power transfer torque is realized, the output torque of the clutch brake assembly 2 is further increased, a better soft starting effect is achieved, and the influence of the loading impact on a power transmission system is reduced.

When the actuator is in a hydraulic driving type, the clutch actuator 244 and the brake actuator 254 may share one control oil path and control logic, and the control logic, for example, is pressure. When the first power turbine 1123 is in an idle mode, the clutch mechanism 24 may be in the closed state by slightly controlling the pressure of the oil path, and a certain load is provided for the first power turbine 1123.

According to the oil path pressure control, the spring force of the second elastic reset element 255 may be firstly overcome, so that the friction of the brake friction plate set 253 in the brake mechanism 25 will be reduced, the brake force capable of being provided will also be reduced, but will still be greater than the moment generated by the brake friction plate set 253, so that the output shaft 23 is continuously braked. When the first power turbine 1123 is converted from the idle mode into the work mode, the pressure of the clutch actuator 244 is controlled to be slowly increased, the torque generated by the clutch friction plate set 242 is increased, the braking capability of the brake mechanism 25 is gradually reduced, and when the total output torque of the clutch mechanism 24 is greater than the load, the output shaft 23 starts to rotate. At this moment, the clutch actuator 244 is maintained at the proper control pressure, so that the output end of the clutch mechanism 23 slowly accelerates to the same speed as the input end or a similar speed to the input end. If the output end does not reach the same speed as the input end or the similar speed to the input end in the process, acceleration is not performed any more, and the control pressure of the clutch actuator 244 is continuously and slowly increased. When the output end and the input end are at the same speed or similar speed, the control pressure of the clutch actuator 244 is directly raised to the maximum control pressure.

The pressure set of the maximum control oil path of the clutch actuator 244 may be determined according to a transfer torque limitation value. When the transfer torque exceeds a limitation torque, relative slippage occurs in the clutch friction plate set 242, and the first power turbine 1123 may be further protected. The torque limitation value, for example, may be but is not limited to 19 KN/m. At the same time, the input and output rotating speed difference of the clutch brake assembly 2 may be monitored to further judge/measure/determine the continuous slippage time of the clutch actuator 244. If the slippage time exceeds a set value, the clutch mechanism 24 is controlled to be in the open state, the brake mechanism 25 is controlled to be in the closed state, so that the long-time slipping abrasion of the clutch friction plate set 242 can be avoided, and the service life of the clutch mechanism 24 is effectively prolonged.

When the actuator is in a hydraulic driving mode, the clutch actuator 244 and the brake actuator 254 may be respectively independent control oil paths and control logics. When the first power turbine 1123 is in the idle mode, the pressure of the control oil path of the brake actuator 254 is maintained to be zero. At this moment, the brake actuator 254 is completely in a brake state under the effect of the spring force of the second elastic reset element 255. The control oil path of the clutch actuator 244 only needs to provide smaller pressure, a proper torque is further generated to balance the torque of the first power turbine 1123, so that the first power turbine 1123 is maintained at a certain rotating speed.

When the first power turbine 1123 converts from the idle mode to the work mode, the brake friction plate set 253 in the brake mechanism is firstly controlled to be completely separated, then, the pressure of the control oil path of the clutch actuator 244 is slowly increased, the slow loading is realized, the soft starting of the fracturing pump 33 is further completed, the load impact on the first power turbine 1123 and transmission components is effectively reduced, and the service life is prolonged.

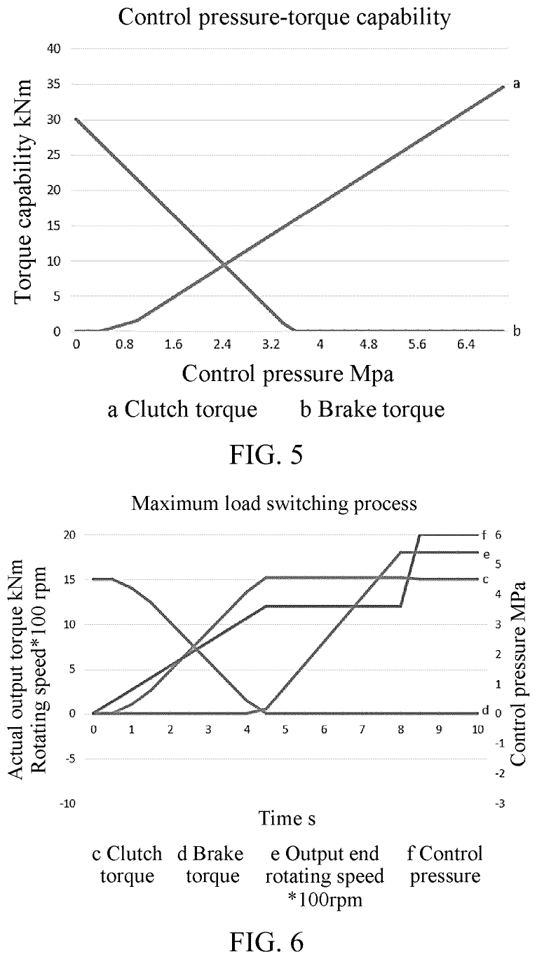

As shown in FIG. 5, when the clutch actuator is in a hydraulic driving mode, FIG. 5 shows a schematic diagram of control pressure and transfer torque capability relationship curves of the clutch actuator.

### Embodiment II

As shown in FIG. 2 and FIG. 4, the fracturing device includes a driving mechanism 1, a clutch brake assembly 2, a fracturing apparatus 3 and an auxiliary driving mechanism 4. The driving mechanism 1, the clutch brake assembly 2, the fracturing apparatus 3 and the auxiliary driving mechanism 4 have been described in details in the above embodiments, and will not be repeated herein. Only the combination mode will be further illustrated herein.

The driving mechanism 1 includes a gas turbine engine 11 and a first reduction gear box 12, the gas turbine engine 11 is a gas turbine single-shaft engine 111, and the first reduction gear box 12 is a high-speed reduction gear box. A motor is disposed in the first reduction gear box 12 so that the first reduction gear box may be singly driven.

The fracturing apparatus 3 includes a third reduction gear box 31, a fourth reduction gear box 32 and a fracturing pump 33 which are in sequential connection. The third reduction gear box 31 and the fourth reduction gear box 32 are in integral arrangement.

When the second power turbine 1113 in the gas turbine single-shaft engine 111 is started, and the piston pump output of the fracturing pump 33 is not needed, or only the auxiliary driving mechanism 4 needs to drive a piston pump of the fracturing pump 33, the clutch mechanism 24 is controlled to be in the open state, and the brake mechanism 25 is controlled to be in the closed state to cut off the power transmitted from the second power turbine 1113 to the fracturing pump 33, the piston pump of the fracturing pump 33 is braked, and the rotating speed is zero. The second power turbine 1113 continuously rotates, a sun gear in the first reduction gear box 12 is braked to ensure a planetary carrier of the second reduction gear box 41 to be able to drive the piston pump of the fracturing pump 33 to rotate when the auxiliary driving mechanism 4 drives a gear ring of the second reduction gear box 41.

When the second power turbine 1113 starts, the piston pump output of the fracturing pump 33 is not needed, the state is switched to that only the second power turbine 1113 drives the piston pump of the fracturing pump 33, the clutch mechanism 24 is controlled to be in a the closed state, and the brake mechanism 25 is controlled to be in the open state. The slow increase of the transfer torque is realized by slowly controlling the clutch and brake process, the start torque of the output end of the clutch mechanism 24 is reduced, and a better soft starting effect is achieved.

When the actuator is in a hydraulic form, the clutch actuator 244 and the brake actuator 254 share one control path and control logic, the control pressure of the clutch actuator 244 is slowly increased, the torque generated by the clutch friction plate set 242 is increased, the braking capability of the brake mechanism 25 is gradually reduced, when the total output torque of the clutch mechanism 24 is greater than the load, the output end of the clutch mechanism 24 starts to rotate in an accelerated manner. At this moment, a proper control pressure is maintained, so that the output end of the clutch mechanism 24 slowly accelerates to the same speed as the input end or a similar speed to the input end. If the same speed as the output end or the similar speed to the output end is not reached in the process, the control pressure is continuously and slowly increased. When the output end and the input end are at the same speed or similar speed, the control pressure is directly raised to the maximum control pressure. The maximum pressure control may be set according to the transfer torque limitation value. After the transfer torque exceeds the limitation torque, relative slippage occurs in the clutch friction plate set 242, and the second power turbine 1113 may be protected. At the same time, the continuous slipping time of the clutch friction plate set 242 may be judged by monitoring the rotating speed difference between the input end and the output end. When the time exceeds a set value, the clutch mechanism 24 is controlled to be in the open state, and the brake mechanism 25 is controlled to be in the closed state, so that the long-time slipping abrasion of the clutch friction plate set 242 can be avoided, and the service life of the clutch mechanism 24 is effectively prolonged.

When a process that only the auxiliary driving mechanism 4 drives the piston pump of the fracturing pump 33 is switched to a process that only the second power turbine 1113 drives the piston pump of the fracturing pump 33, the control process is similar to the process in Embodiment I, i.e., the piston pump output of the fracturing pump 33 is not needed, and the process is switched to that only the second power turbine 1113 drives the piston pump of the fracturing pump 33. The difference is only that at the early switching stage, in the above switching process, the torque of the brake mechanism 25 and the output torque of the clutch mechanism 24 are in opposite directions. With the control pressure rising, the output torque of the clutch mechanism 24 overcomes the torque of the brake mechanism 25 and the load to do work to the outside. According to the switching process in the present embodiment, when the auxiliary driving mechanism 4 drives the piston pump of the fracturing pump 33, the sun gear in the second reduction gear box 41 has the reverse rotation trends relative to the output of the clutch mechanism 24. At the early switching stage, the torque of the brake mechanism 25 is braked by the sun gear of the second reduction gear box 41, and the direction is the same as the output torque direction of the clutch mechanism 24. With the control pressure increasing, the output torque of the clutch mechanism 24 gradually replaces the torque of the brake mechanism 25 to brake of the sun gear of the second reduction gear box 41. After the complete replacement, there may be a process that the torque of the brake mechanism 25 and the output torque of the clutch mechanism 24 are opposite. With the control pressure increasing, the output torque of the clutch mechanism 24 overcomes the torque of the brake mechanism 25 and the load to do work to the outside. At the same time, in order to realize the switching from a process that only the auxiliary driving mechanism 4 drives the piston pump of the fracturing pump 33 to a process that only the second power turbine 1113 drives the piston pump of the fracturing pump 33, the output rotating speed of the auxiliary driving mechanism 4 needs to be gradually decelerated in the combination process of the clutch mechanism 24. The output end rotating speed of the clutch mechanism 24 may be used as a rotating speed adjusting basis of an adjustable-speed motor, and the rotating speed of the adjustable-speed motor may be decreased to the equal proportion along with the rotating speed rise of the output end of the clutch mechanism 24. For example, at a certain moment, the output end rotating speed of the clutch mechanism 24 is 10% of the rotating speed after the normal closing. At this moment, the rotating speed of the adjustable-speed motor shall be controlled to be adjusted to 90% (1-10%) of the rotating speed of the adjustable-speed motor before the normal closing of the clutch mechanism 24. Or, the relationship may be another following control relationship, for example, the rotating speed of the clutch mechanism 24 is raised by X rpm, the rotating speed of the adjustable-speed motor is correspondingly controlled to be reduced by nX rpm (n is a constant coefficient), and the specific condition is according to the actual situations.

When the actuator is in a hydraulic driving mode, the clutch actuator 244 and the brake actuator 254 may be respectively independent control oil paths and control logics. In this switching process, the control pressure of the clutch mechanism 24 is firstly raised to a certain set value. The set value can be determined according to the load. Then, the brake mechanism 25 is controlled to be completely separated. Next, the control pressure of the clutch mechanism 24 is slowly increased, the subsequent control logic is the same as the above mode. It will not be repeated herein.

In the present embodiment, in the transmission system using the gas turbine single-shaft engine 111 as a prime mover, the zero-load starting of the second power turbine 1113 and the soft starting of the fracturing pump 33 are realized. At the same time, the switching between two power driving modes of the turbine direct driving mode and the motor direct driving mode in a hybrid power transmission system can be realized, and the stable handover can be realized.

As shown in FIG. 6, FIG. 6 shows a schematic diagram of change curves of each parameter along with time in the combination process when the load is a certain constant value in the process in a case that the clutch actuator is in a hydraulic control form.

### Embodiment III

As shown in FIG. 3 and FIG. 4, a fracturing device includes a driving mechanism 1, a clutch brake assembly 2, a fracturing apparatus 3 and a gear box 5. The driving mechanism 1, the clutch brake assembly 2, the fracturing apparatus 3 and the gear box 5 have been described in details in the above embodiments, and will not be repeated herein. Only the combination mode will be further illustrated herein.

The driving mechanism 1 includes a gas turbine engine 11 and a first reduction gear box 12, the gas turbine engine 11 is a gas turbine double-shaft engine 112, and the first reduction gear box 12 is a planetary reduction gear box.

The fracturing apparatus 3 includes a third reduction gear box 31, a fourth reduction gear box 32 and a fracturing pump 33 which are in sequential connection. The third reduction gear box 31 and the fourth reduction gear box 32 are in integral arrangement.

The driving mechanism 1 includes a gas turbine engine 11 and a first reduction gear box 12, the gas turbine engine 11 is a gas turbine single-shaft engine 111, and the first reduction gear box 12 is a high-speed reduction gear box. A motor does not need to be singly disposed in the first reduction gear box 12.

The fracturing apparatus 3 includes a third reduction gear box 31, a fourth reduction gear box 32 and a fracturing pump 33 which are in sequential connection. The third reduction gear box 31 and the fourth reduction gear box 32 are in split arrangement.

In the present embodiment, a gear box 5 is disposed, the clutch brake assembly 2 and the gear box 5 are in parallel arrangement, the input end of the gear box 5 is connected to the other output end of the first reduction gear box 12, the output end of the gear box 5 is connected to the other input end of the third reduction gear box 31, i.e., a gear ring of the third reduction gear box 31 is driven. The position of the clutch brake assembly 2 and the position of the gear box 5 can be exchanged.

When the second power turbine 1113 starts, and the piston pump output of the fracturing pump 33 is not needed, or only piston pump of the fracturing pump 33 needs to be driven by the gear box 5, the clutch mechanism 24 is controlled to be in the open state, and the brake mechanism 25 is in a the closed state, so that the power output from the second power turbine 1113 and transmitted to the piston pump is cut off. At the same time, a sun gear of the third reduction gear box 31 is braked so as to ensure a planetary carrier of the third reduction gear box 31 to be able to drive the piston pump to rotate when the gear box 5 drives a gear ring of the third reduction gear box 31.

When the third reduction gear box 31 starts, and the piston pump output of the fracturing pump 33 is not needed, the operation is switched to that only the second power turbine 1113 directly drives the piston pump through the clutch brake assembly 2, the switching process is similar to the switching process in Embodiment I, and it will not be repeated herein.

When the process that only the gear box 5 drives the piston pump is switched into the process that only the second power turbine 1113 directly drives the piston pump through the clutch brake assembly 2, the control process is similar to the switching process sin Embodiment II. The difference is only that the gear box 5 needs to reduce the shift in a manner of one shift by one shift with the continuous rise of the output rotating speed of the clutch brake assembly 2, the output rotating speed of the gear box 5 is further reduced to reach a neutral position and zero output rotating speed.

In the present embodiment, in the transmission system using the gas turbine single-shaft engine 111 as a prime mover, the zero-load starting of the second power turbine 1113 and the soft starting of the fracturing pump 33 are realized. At the same time, the switching between two power driving modes of the turbine direct driving mode and the motor direct driving mode in a hybrid power transmission system can be realized, and the stable handover can be realized.

It should be understood that the terms used herein are intended only to describe specific exemplary embodiments but are not intended for limitation. Unless otherwise specified, the singular forms “one”, “a”, and “the” used herein may also include the plural form. The terms “include”, “contain”, “comprise” and “have” are inclusive, and thus indicate the existence of the stated features, steps, operations, elements and/or components, but do not exclude the existence or addition of one or more other features, steps, operations, elements, components and/or combinations thereof. The method steps, processes and operations described herein are not interpreted as requiring that they should be performed in a particular order as described or illustrated, unless the execution order is explicitly indicated. It should also be understood that additional or alternative steps can be used.

Although the terms first, second, third, etc. may be used herein to describe multiple elements, components, regions, layers and/or segments, these elements, components, regions, layers and/or segments should not be limited by these terms. These terms may be used only to distinguish one element, component, region, layer or segment from another. Unless otherwise explicitly specified, terms such as “first” and “second” and other numerical terms do not imply the order or sequence when being used herein. Therefore, the first element, component, region, layer or segment discussed below may be referred to as the second element, component, region, layer or segment without departing from the teaching of the exemplary embodiments.

The above is only specific implementations of the present application for the purpose of enabling persons skilled in the art to understand or implement the present application. Various modifications to these embodiments will be apparent to those skilled in the art, and general principles defined herein may be realized in other embodiments without departing from the spirit or scope of the present application. Therefore, the present application will not be limited by these embodiments herein, but will conform to the widest range consistent with the principles and novel features applied herein.

What is claimed is:

1. A fracturing device, comprising a driving mechanism, a clutch brake assembly and a fracturing apparatus, wherein
the clutch brake assembly comprises a housing, an input shaft, an output shaft, a clutch mechanism and a brake mechanism;
the output shaft is rotatably installed in the housing;
the clutch mechanism and the brake mechanism are respectively disposed at two sides in an axial direction of the clutch brake assembly, and are sheathed on the output shaft;
one end of the input shaft is connected with the driving mechanism;
the other end of the input shaft penetrates into the housing and is respectively connected with the clutch mechanism which is connected to one end of the output shaft; and
the other end of the output shaft penetrates out of the housing to be connected with the fracturing apparatus.

2. The fracturing device according to claim 1, wherein:
the clutch mechanism comprises a clutch outer gear sleeve, a clutch friction plate set and a clutch inner gear sleeve sequentially disposed in a radial direction of the clutch brake assembly;
the clutch inner gear sleeve is connected with the input shaft;
the clutch outer gear sleeve is sheathed on the output shaft;
the clutch friction plate set is respectively connected with the clutch inner gear sleeve and the clutch outer gear sleeve;
the clutch mechanism further comprises a clutch actuator and a first elastic reset element;
the clutch actuator and the first elastic reset element are positioned between the clutch outer gear sleeve and the clutch inner gear sleeve;
the clutch actuator is connected with the clutch friction plate set;
the first elastic reset element is connected with the clutch actuator; and
the clutch actuator is configured to drive the clutch friction plate set to slide in an axial direction of the clutch brake assembly so that the clutch mechanism is in an open or closed state.

3. The fracturing device according to claim 2, wherein:
the clutch friction plate set comprises a plurality of first clutch friction plates and a plurality of second clutch friction plates;
the first clutch friction plates and the second clutch friction plates are sequentially disposed in a crossed manner in the axial direction of the clutch brake assembly;
the first clutch friction plates are connected with the clutch inner gear sleeve;
the second clutch friction plates are connected with the clutch outer gear sleeve; and
the clutch actuator is configured to drive the first clutch friction plates and the second clutch friction plates to slide in the axial direction of the clutch brake assembly.

4. The fracturing device according to claim 2, wherein:
the brake mechanism comprises a brake inner gear sleeve, a brake outer gear sleeve and a brake friction plate set;
the brake inner gear sleeve is fixedly connected with the housing; the brake outer gear sleeve is sheathed on the output shaft; the brake friction plate set is respectively connected with the brake inner gear sleeve and the brake outer gear sleeve;
the brake mechanism further includes a brake actuator and a second elastic reset element;
the brake actuator and the second elastic reset element are positioned between the brake inner gear sleeve and the brake outer gear sleeve;
the brake actuator is connected with the brake friction plate set;
the second elastic reset element is connected with the brake actuator; and
the brake actuator is configured to drive the brake friction plate set to slide in an axial direction of the clutch brake assembly so that the brake mechanism is in an open or closed state.

5. The fracturing device according to claim 4, wherein:
the brake friction plate set comprises a plurality of first brake friction plates and a plurality of second brake friction plates;
the first brake friction plates and the second brake friction plates are sequentially disposed in a crossed manner in the axial direction of the clutch brake assembly;
the first brake friction plates are connected with the brake inner gear sleeve;
the second brake friction plates are connected with the brake outer gear sleeve; and
the brake actuator is able to drive the first brake friction plates and the second brake friction plates to slide in the axial direction of the clutch brake assembly.

6. The fracturing device according to claim 1, wherein:
the clutch brake assembly further comprises an oil passage; and
the oil passage penetrates through the housing and communicates with the brake mechanism and/or the clutch mechanism.

7. The fracturing device according to claim 1, wherein:
the driving mechanism comprises a gas turbine engine and a first reduction gear box;
the gas turbine engine is connected with the first reduction gear box;
the first reduction gear box is connected with the clutch mechanism through the input shaft; and
the gas turbine engine is a gas turbine single-shaft engine or a gas turbine double-shaft engine.

8. The fracturing device according to claim 7, wherein, when the gas turbine engine is a gas turbine single-shaft engine:
the fracturing device further comprises an auxiliary driving mechanism;
one side of the auxiliary driving mechanism is connected with the brake mechanism through the output shaft; and
the other side of the auxiliary driving mechanism is connected with the fracturing apparatus.

9. The fracturing device according to claim 8, wherein:
the auxiliary driving mechanism comprises a second reduction gear box, an adjustable-speed driving motor and the other clutch brake assembly;
the adjustable-speed driving motor is connected to the second reduction gear box through the other clutch brake assembly; and
the second reduction gear box is respectively connected with the output shaft and the fracturing apparatus.

10. The fracturing device according to claim 7, wherein when the gas turbine engine is a gas turbine single-shaft engine:
the fracturing device further comprises a gear box, and the gear box is disposed in parallel to the clutch brake assembly;
one side of the gear box is connected with the first reduction gear box; and
the other side of the gear box is connected with the fracturing apparatus.

11. The fracturing device according to claim 1, wherein:
the fracturing apparatus comprises a second reduction gear box, a third reduction gear box and a fracturing pump in sequential connection;
the second reduction gear box is positioned at one side near the clutch brake assembly; and
the fracturing pump is positioned at one side far away from the brake clutch assembly.
